(19) United States
(12) Patent Application Publication
(10) Pub. No.: US 2019/0320752 A1
(43) Pub. Date: Oct. 24, 2019

(54) Cloth tab that attaches hat to eyeglasses strap

(71) Applicant: Albert Watkins Key, JR., Mobile, AL (US)

(72) Inventor: Albert Watkins Key, JR., Mobile, AL (US)

(21) Appl. No.: 16/385,521

(22) Filed: Apr. 16, 2019

Related U.S. Application Data
(60) Provisional application No. 62/660,442, filed on Apr. 20, 2018.

(51) Int. Cl. A42B 1/24; A44B 18/00; G02C 3/02

(52) U.S. Cl. CPC A42B 1/247; G02C 3/02; A44B 18/003

(57) ABSTRACT

Cloth tab with fastener sewn onto the back of headwear that serves to couple the headwear to eyeglasses straps. Either, or both, of the headwear or eyeglasses can be removed and they will hang from the tab and remain in proximity to the user without the user having to hold either item. The cloth tab is comprised of cloth and fastener such as Velcro snap, or button. The cloth tab is sewn onto the adjustment strap of headwear.

### CROSS-REFERENCE TO RELATED APPLICATIONS

The present application claims the benefit of U.S. Patent Application No. 62/660,442 for A cloth tab that attaches a hat to eyeglasses straps filed Apr. 20, 2018, which is hereby incorporated by reference in its entirety.

### BACKGROUND OF THE INVENTION

### Field of the Invention: CPC A42B7/00

The present invention relates to headwear fastening devices and more particularly to a new headwear securing device for securing headwear to eyeglasses straps.

Headwear and eyeglasses, especially in the form of sunglasses, are commonly worn together. Additionally, the use of eyewear securing straps are commonly used to retain eyeglasses, especially in outdoor activities such as fishing, sailing, snow sports, and jogging. Some actions of these activities require that either the headwear or eyeglasses be removed such as wiping the forehead or lowering eyeglasses to see better. Additionally, headwear can be lost in the course of such activities by means of high wind. A retention device that connects headwear and eyeglasses secures the headwear against loss and allows for the user to retain use of both hands for convenience and safety. For example, when riding in a boat at high speeds a person wants both hands to hold onto the vessel and does not want to worry about losing their headwear.

Other headwear retention devices are not built into the headwear. While these devices serve their particular purposes, they are not convenient and adaptable to different models of sunglasses straps.

Thus, there is a need for a more convenient and adaptable retention device that allows for headwear and eyeglasses to be retained in proximity to the user without that user having to hold on to either item.

### BRIEF SUMMARY OF THE INVENTION

The present invention meets the needs described above by attaching headwear to eyeglasses straps by means of a cloth tab and fastener sewn into the adjustment strap of headwear.

### BRIEF DESCRIPTION OF THE DRAWINGS

FIG. 1 is a frontal view of the cloth tab using Velcro as a fastener. Different fastening hardware will not change the dimensions of the cloth tab.

FIG. 2 is a side view of the cloth tab using Velcro as a fastener.

FIG. 3 is a rear view of a hat with the cloth tab and Velcro fastener attached. This cloth tab is attached by sewing the cloth tab onto the adjustment strap of the hat.

FIG. 4 is a rear view of a hat with eyeglasses strap attached to the hat by folding the cloth tab into the closed/fastened position.

FIG. 5 is a side view of both eyeglasses and hat in an active state of wear while coupled together by the tab in the closed/fastened position.

FIG. 6 is a side view of hat in an active state of wear while inactive eyeglasses are retained by the closed/fastened tab.

FIG. 7 is a side view of eyeglasses in an active state of wear while inactive hat is retained by the closed/fastened tab.

### DETAILED DESCRIPTION OF THE INVENTION

As stated above. headwear is often blown off. The invention claimed here solves this problem.

Headwear is retained by the tab when blown off.

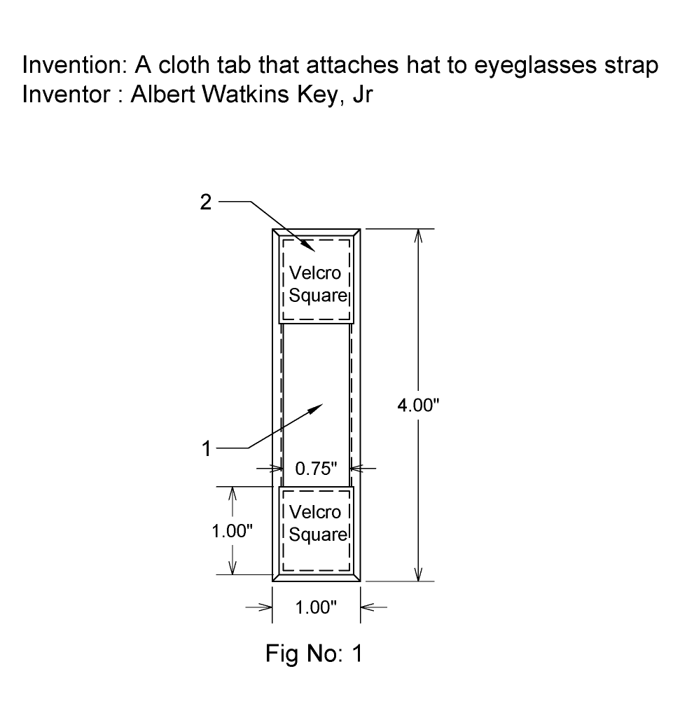

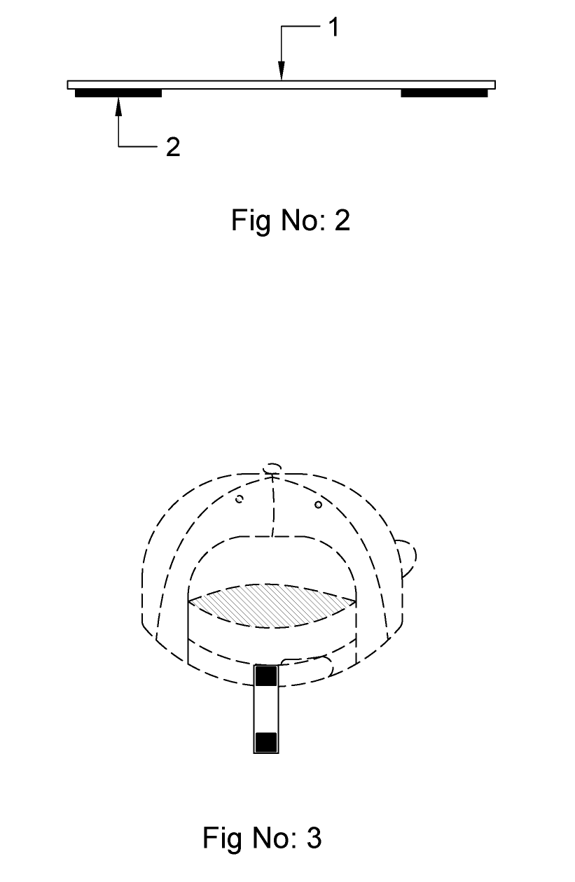

The version of the invention discussed here includes:
1. The tab as illustrated in FIG. 1, item 1.
2. The fastener securing the tab to eyeglasses strap as illustrated in FIG. 1, item 2.

Relationship Between The Components: The tab is fastened with the fastener

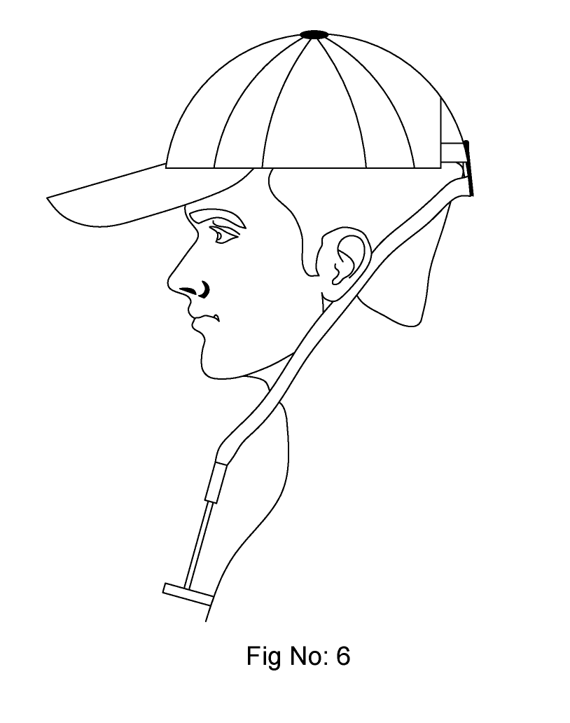

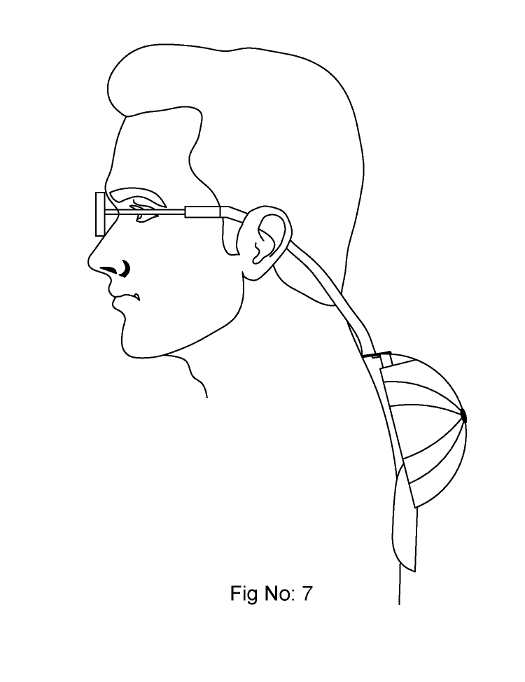

How The Invention Works: A cloth tab couples headwear to eyeglasses strap as shown in FIG. 5. When headwear or eyeglasses are blown off or removed the eyeglasses strap retains them as shown in FIG. 6 and FIG. 7.

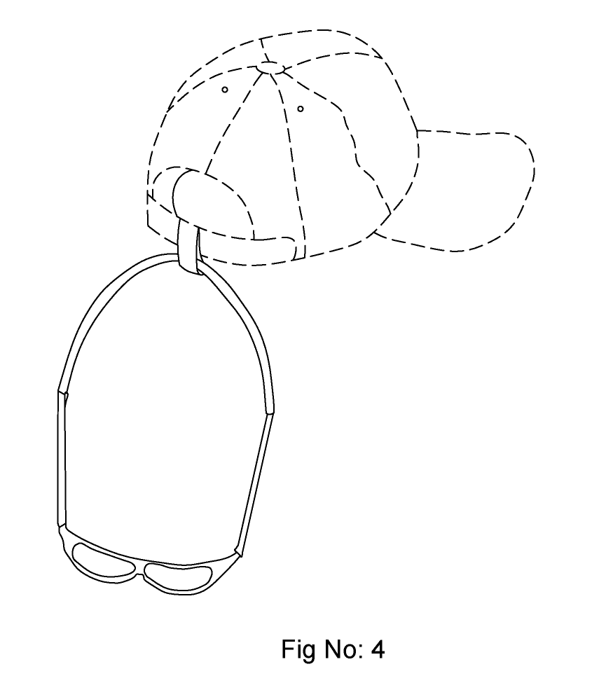

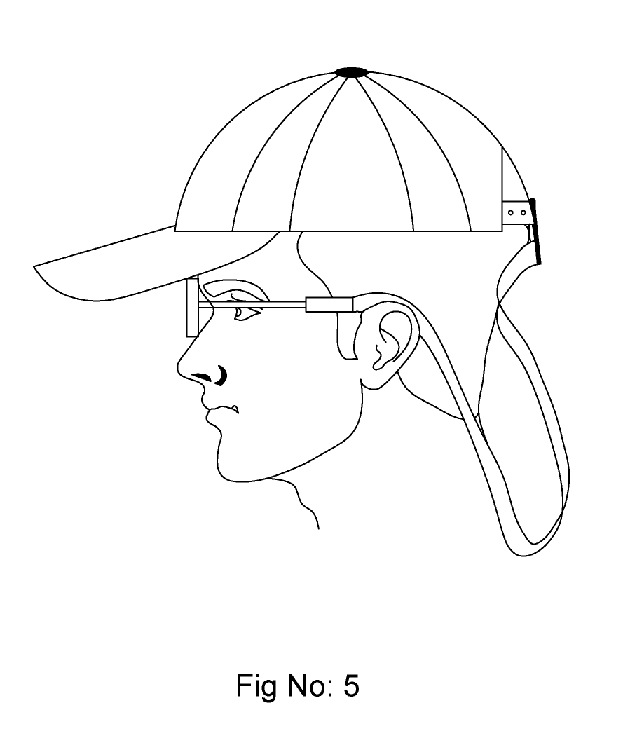

How To Make The Invention:
1. Cut cloth approximately 4.25×1.25 inches.
2. Fold approximately 0.125 inches inward on all four sides and sew to create a cloth tab with reinforced edges approximately 4×1 inches.
3. Attach fastener to each extreme end of cloth tab to form cloth tab as shown in FIG. 1.
4. Sew one of the narrow ends of the cloth tab to the adjustment strap of headwear with fasteners facing out as shown in FIG. 3.

Components: Headwear with adjustable strap, cloth, and fastener are included. The headwear may be part of some versions of the invention, but is not presently claimed as part of the invention. Different types of cloth and fasteners can be used to make the invention work better. For example, a tab for fisherman could be made of Dri-fit cloth with a stainless steel snap to prevent rusting.

How To Use The Invention: Fasten the tab around eyeglasses strap as shown in FIG. 5.

1. A cloth tab sewn onto headwear to couple eyeglasses strap to headwear comprised of:
a. A cloth tab approximately 4×1 inch;
b. A male and female fastener permanently installed at each extreme end of the cloth tab so that the cloth tab can be folder lengthwise over eyeglasses strap and fastened to create a retaining loop.

2. The cloth tab of claim 1, wherein the cloth tab, when in the closed/fastened position, has enough strength to retain the headwear when blown off.

3. The cloth tab of claim 1, wherein the fasteners are Velcro, steel snaps, buttons, or other fastening systems suitable for the environment of the wearer of the headwear.

4. The cloth tab of claim 1, wherein the narrow end of the cloth tab is sewn to the rear fastening/adjustment system of the headwear.
